(19) United States
(12) Patent Application Publication
(10) Pub. No.: US 2002/0194055 A1
(43) Pub. Date: Dec. 19, 2002

(54) Computer system for analyzing customer needs

(75) Inventors: Keiji Takakura, Tokyo (JP); Michitada Kameoka, Tokyo (JP); Masato Honjo, Tokyo (JP)

Correspondence Address: ARENT FOX KINTNER PLOTKIN & KAHN, PLLC, 1050 Connecticut Avenue, N.W., Suite 400, Washington, DC, 20036-5339, US

(73) Assignee: HONDA GIKEN KOGYO KABUSHIKI KAISHA

(21) Appl. No.: 10/112,949

(22) Filed: Apr. 2, 2002

(30) Foreign Application Priority Data
Apr. 26, 2001 (JP) 2001129792

(51) Int. Cl. G06F 17/60

(52) U.S. Cl. 705/10

(57) ABSTRACT

There is provided a sales support system capable of being operated without substantially degrading reliability even if basic attribute data required for identifying needs property of the customers is insufficient.

The system is a computer system that analyzes information concerning customers, comprising a customer database for storing data on a basic factor for understanding a customer and a customer comprehension engine for analyzing needs property of the customers based on the basic factor; wherein the customer database stores an interpolation factor to be used in place of the basic factors if the data on the basic factor is absent, and the customer comprehension engine is programmed so as to use a interpolation factor corresponding to the basic factor to calculate the needs property of the customers if the data on the basic factor required calculating the needs property of the customers is absent.

### BACKGROUND OF THE INVENTION

1. Filed of the Invention

The present invention relates to a computer system for storing in a database the attributes of customers that include understanding factors concerning purchasing activities and for supporting sales based on analysis of the attributes.

2. Description of the Related Art

Japanese Patent Laid-Open No. 5-101108 describes a scheme wherein correlations between attribute data items concerning a customer that are stored in a customer database are examined. Product articles suitable for the customer are selected based on the correlation to support sales activities. The attribute data are updated based on the results of sales activities. The scheme enables proposition sales activities according to potential needs of individual customers.

Japanese Patent Laid-Open No. 10-83427 describes a sales support system capable of providing information concerning a campaign that is likely to meet the interest of a customer immediately after an inquiry from the customer. This system includes a database storing a table indicating, for each sales item, the relation between conditions of the customers and potential values corresponding to the ratio of customers relevant to the sales item to the customers meeting the conditions. The system refers to the table based on customer information to display relevant items on a display unit.

For products having long life cycles, it is required that a company identifies the property of individual customers and performs sales activities according to the property. With the widespread use of the Internet, there are tendencies for customers to collect product information on the Internet. These activities of the customers are very important from the viewpoint of sales promotion. However, conventional sales support systems do not sufficiently incorporate these customer activities to sales support data.

Japanese Unpublished Patent Application No. 2000-396577 assigned to the same assignee as the present application proposes a sales support system that stores and manages information about customers. The system comprises a customer database for storing basic customer attribute data including factors for understanding customers with respect to product purchase, a Web site for providing an enterprise Web page on the Internet, a Web activity history database for storing a Web activity history for each customer based on log data in the enterprise Web page, and a customer comprehension engine for analyzing property of customer needs based on data contained in the customer database and determining the timing of working-on-a-customer customers based on the Web activity history.

To increase the practical utility of the prior application, it is important to properly identify needs property of the customers. It is an object of the present invention to provide a sales support system capable of being operated without substantially degrading reliability even if basic attribute data required for identifying such needs property of the customers is insufficient.

### SUMMARY OF THE INVENTION

The present invention provides a computer system for analyzing information concerning customers. The system comprises a customer database for storing data on basic factors for understanding the customers and a customer comprehension engine for analyzing property of customer needs based on the basic factors. The customer database stores an interpolation factor to be used in place of the basic factors if the data on the basic factor is absent. The customer comprehension engine is programmed so as to use interpolation factors corresponding to the basic factors to calculate the needs property of the customers if the data on the basic factor required in calculating the needs property of the customers is absent.

According to the present invention, if one or more of basic factors required for analyzing the property of the customer need are absent, the property of the customer need can be calculated by using interpolation factors corresponding to the absent basic factors, thereby preventing a situation in which the calculation of the need characteristic cannot be performed or a significant degradation is caused in reliability of the calculation due to lack of the data.

According to one embodiment of the present invention, needs property of the customers includes one or more of information needs, support needs, product checking needs, service needs, and human dependency. The customer comprehension engine is programmed so as to activate a process for working-on-a-customer for obtaining data if the data on the interpolation factors is absent.

In one embodiment of the present invention, the above-mentioned process includes the step of selecting for a given customer a contact channel with a high preference rank.

In one aspect of the invention, the invention provides a computer system for analyzing information concerning a customer. The system comprises a database for storing data on basic factors for understanding the customers and a customer comprehension engine for analyzing property of the needs of the customer based on the basic factors.

The system is programmed so as to activate a process for working-on-a-customer in order to obtain relating data if data on a basic factor required in calculating the needs property of the customers is absent.

In one embodiment of the present invention, data on an interpolation factor is used in place of the data on the basic factor if the relating data cannot be acquired by performing the working-on-a-customer.

### BRIEF DESCRIPTION OF THE DRAWINGS

FIG. 1 is a block diagram of a general configuration of a system according to one embodiment of the present invention.

FIG. 2 is a flowchart of a general process flow according to one embodiment of the present invention.

FIG. 3 is a flowchart of a process flow for determining identification result rank variables according to one embodiment of the present invention.

FIG. 4 is a diagram showing classification of use identification information according to one embodiment of the present invention.

FIG. 5 shows an example of the calculation of rank variables according to one embodiment of the present invention.

FIG. 6 is a flowchart of a process of working-on-a-customer determination process according to one embodiment of the present invention.

FIG. 7 show an example of the calculation of a content browse influence value according to one embodiment of the present invention.

FIG. 8 shows exemplary content browse influence values and working-on-a-customer determination reference values according to one embodiment of the present embodiments.

FIG. 9 is a block diagram of a process for generating working-on-a-customer contents according to one embodiment of the present invention.

FIG. 10 shows the process of generating a message for working-on-a-customer according to one embodiment of the present invention.

FIG. 11 shows a flow of a working-on-a-customer process according to one embodiment of the present invention.

FIG. 12 shows a flow of a database update process based on the results of the working-on-a-customer according to one embodiment of the present invention.

FIG. 13 shows a method for calculating a factor for correcting an influence value in accordance with reception transaction results according to the one embodiment of the present invention.

FIG. 14 shows an example of factors for identifying a customer having a need potentially responsive to working-on-a-customer.

FIG. 15 shows another example of factors for identifying a customer having a need potentially responsive to working-on-a-customer.

FIG. 16 shows yet another example of factors for identifying a customer having a need potentially responsive to working-on-a-customer.

FIG. 17 is a block diagram of a concept of acquisition and update of an absent factor.

FIG. 18 is a flowchart of a process for performing interpolation and automatic acquisition of the absent factor.

FIG. 19 is a flowchart continued from FIG. 18.

FIG. 20 shows an example of a factor set table;

FIG. 21 shows an example of a list of contact channel preference ranks.

FIG. 22 shows an example of a table indicating databases from which factors are acquired.

FIG. 23 is a flowchart of a process flow of discriminant analysis.

### DETAILED DESCRIPTION OF THE PREFERRED EMBODIMENTS

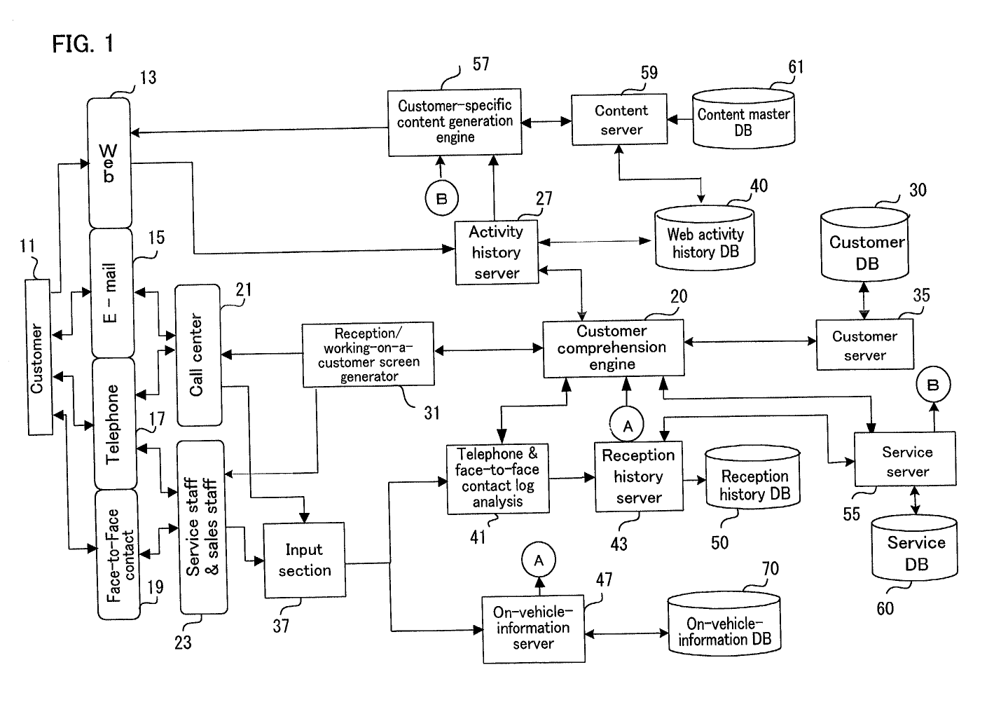

One embodiment of the present invention will be described below with reference to the accompanying drawings. FIG. 1 shows a block diagram of a general configuration of a system according to a preferred embodiment of the present invention. This example illustrates a sales support system of ABC Company, which manufactures and distributes automobiles. Contact means, or interfaces, between a customer 11 and ABC Company include a Web site 13 containing a Web page of ABC Company, e-mail 15, telephone 17, and a face-to-face contact 19 between sales staff or service staff of ABC Company and the customer.

The Web page of the ABC Company includes some pages that anyone can browse without having to providing an ID or a password and the other pages that a user can browse through authentication of an ID and a password, which are registered with ABC Company beforehand. A user may enter in a sign-up form on the Web page information such as his/her name, age, sex, family structure, dwelling type, annual income, information about his/her car, car life stage, uses of the car, hobbies, and driving style, and may send it to the web site for registration of an ID and a password.

A server CGI program on the Web site 13 checks the received sign-up form. If all requisite entries are entered, the Web site 13 grants registration and stores the ID and password in a database. Personal data on a potential purchaser thus obtained is transferred from the database of the Web site to a customer database 30 for storage.

The pages that can be browsed after the verification of the ID and password (called “login”) contain detailed information about products of ABC Company in a hierarchical structure. Each of the pages is called a content. Related contents are linked together in one direction or bi-directionally. Selecting and clicking on a given item on a menu screen typically displays the top page of the item. When one of a number of items contained in the top page is clicked, a page at the next level is displayed. When one of items contained in the page is clicked, a page at the next level is displayed. In this way, the lower a level, the more detailed information can be accessed.

An activity history server 27 detects a login on a customer basis and makes a record (log) of the contents accessed by each customer. The log is stored in a Web activity history database 40. The activity history contains information about the browse of each content, including the number of times the user accessed the content, access frequency, access time, click count, and logout time, as well as content transition information, e-mail transaction information, and rate of induction from e-mail.

The content of the Web page is stored in a content master database 61, is retrieved and sent to the customer by a content server 59. As will be apparent from subsequent description, a customer-specific content generation engine 57 can generate a content that is specific to each customer based on calculation by a customer comprehension engine 20. Such content is sent to the customer.

The system shown in FIG. 1 provides a distributed database system as a whole. The customer comprehension engine 20 can access the Web activity history database 40 managed by the activity history server 27, the customer database 30 managed by a customer server 35, a reception history database 50 managed by a reception history server 43, a service database 60 managed by a service server, and a on-vehicle-information database 70 managed by a on-vehicle-information server 47. The comprehension engine 20 may retrieve data from these databases relative to customers.

Stored in the customer database 30 are customer numbers unique to individual customers, vehicle identification numbers of the cars that are produced by ABC Company and are owned by customers, codes of sales centers and service centers that serve individual customers, and basic attributes of the customers that are input by the customers in the registration process with the Web site.

The reception history server 43 stores reception log concerning each customer in the reception history database 50 based on the results of customer reception, which are input into an input unit 37 by a call center 21 as well as by service staff and sales staff 23. The information may include a reception staff ID, reception date and time, the purpose and description of the reception, reception time, results of reception, expected next reception date and time, the purpose of the next reception. In addition, a record of working-on-a-customer by ABC Company is stored in the reception history database 50. The record may include working-on-a-customer staff IDs, working-on-a-customer date and time, working-on-a-customer period, the description of the working-on-a-customer, and results from the working-on-a-customer.

In response to input of service data by service staff, the reception history server 43 stores service data in the service database 60 via a service server 55. The service data include for each customer such information as service staff IDs, car entry date and time at a repair shop, purpose of car entry, inspection and service information, information on substitution car rent, information on car pick-up, working hours, description of service provided, and invoice information.

The on-vehicle-information server 47 stores data downloaded from an on-vehicle electronic control unit (ECU) into the on-vehicle-information database 70. The database contains for each customer a vehicle identification number (VIN) and driving history information on such items as a daily travel distance, gas mileage, oil contamination, speed, accelerator, brake, lockup, handbrake, blinkers (winker), gasoline gauge, and trouble diagnosis.

The customer comprehension engine 20 calculates needs property of the customers of each customer according to an algorithm, which will be described later, and determines the timing of working-on-a-customer, and generates a message for working-on-a-customer. The result of the calculation by the customer comprehension engine 20 is sent through the activity history server 27 to the customer-specific content generation engine 57. The engine 57 responds to this by generating contents that meets the needs property of the customers of a customer who needs to be worked on. The contents are generated referencing the Web activity history database and the content master database through the content server 59.

An electronic file of contents may be sent by e-mail to the customer to be worked on. When the electronic file is opened on a personal computer of the customer, the browser is activated to allow the file to be browsed. In another embodiment, instead of sending the electronic file directly to the customer of interest, an e-mail message is sent to the customer for notifying that contents specialized for the customer are provided on the Web page and prompting the customer to view the content. The URL of the specialized contents is linked to the e-mail message. When the customer receives the e-mail message, he/she can browse the specialized contents by clicking the URL contained in the e-mail message to visit the Web site of ABC Company.

In yet another embodiment, the results of the calculation by the customer comprehension engine 20 are formed as display frames in the reception/working-on-a-customer screen generator 31 and are sent to the sale staff section 23. A member of the sales staff views the screen on a terminal and contacts the customer of interest according to the information and instructions available on the screen.

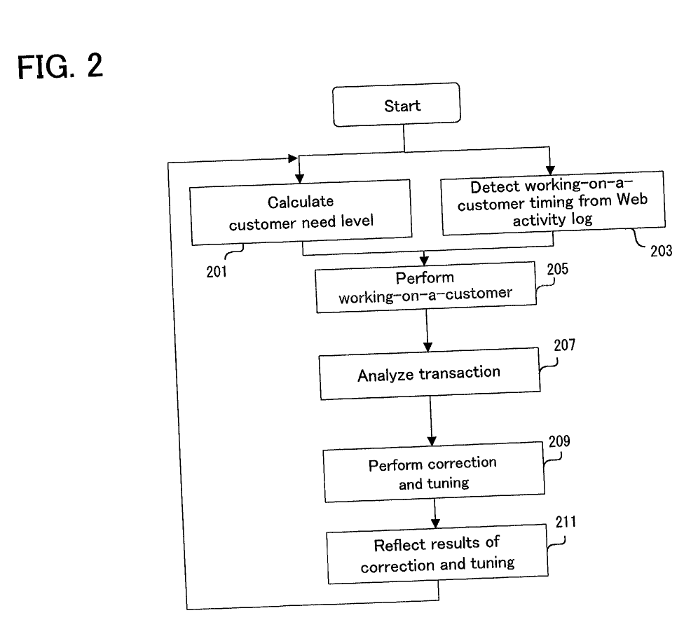

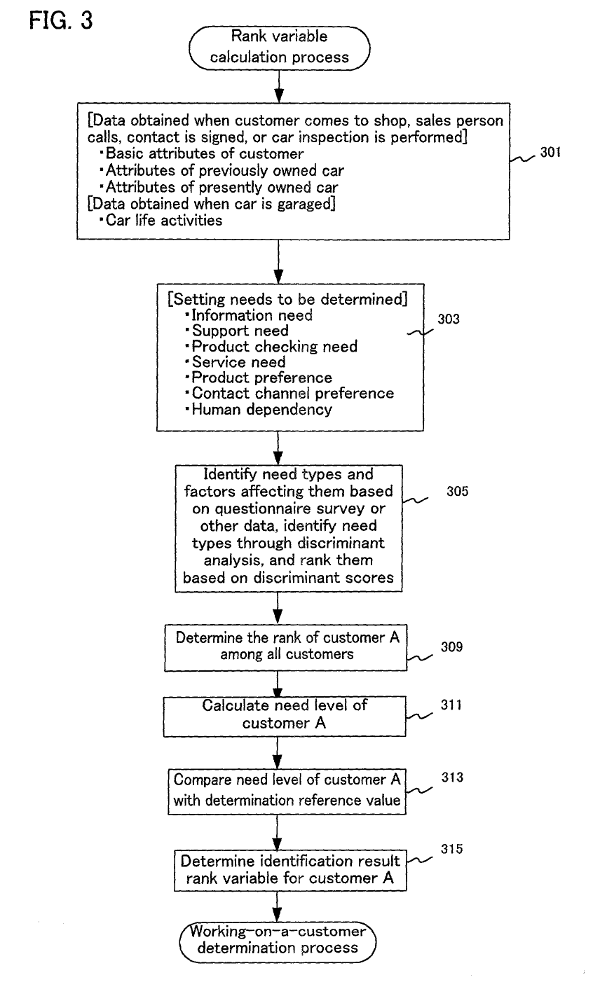

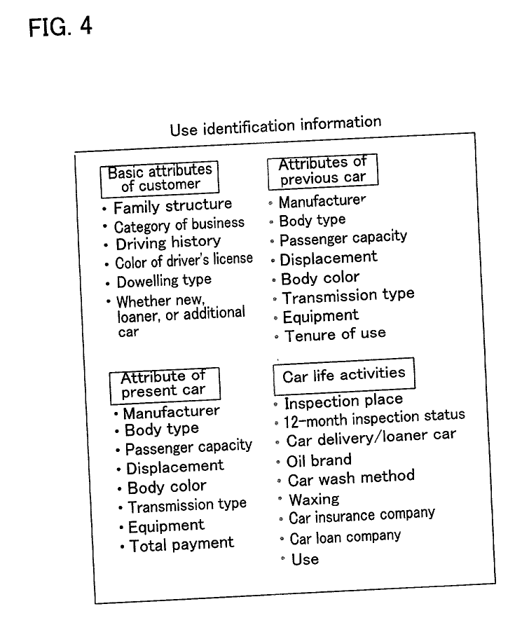

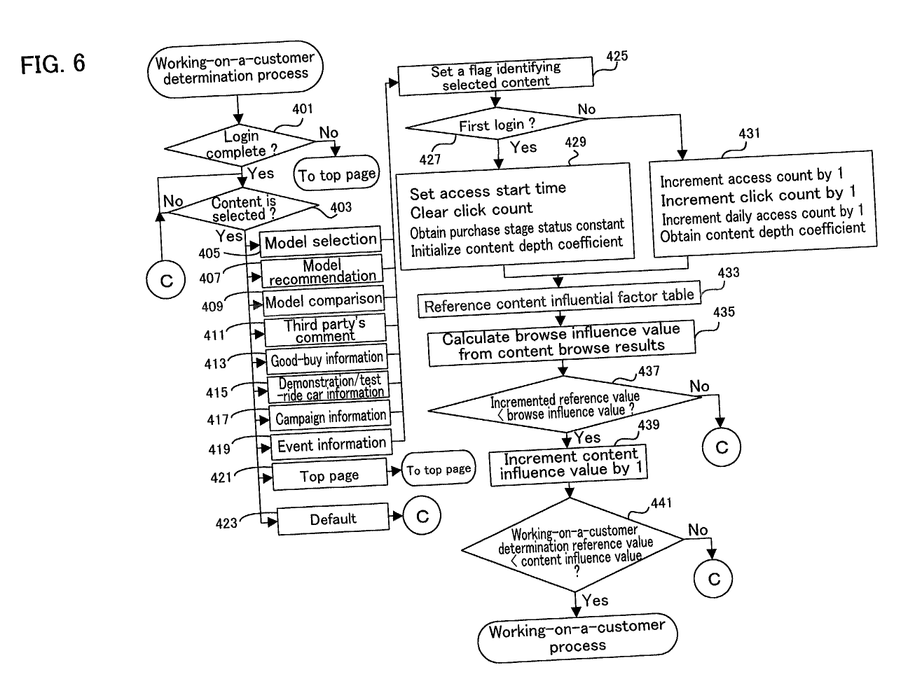

FIG. 2 shows a general flow of a program executed by the customer comprehension engine 20. A need level of a given customer is calculated (201) according to an algorithm, which will be described later with reference to FIGS. 3 through 5. The timing of working on a given customer is detected (203) according to an algorithm, which will be described later with reference to FIGS. 6 through 10. Working-on-a-customer that matches the property of the needs of the customer is performed at the timing thus detected (205). A transaction resulting from the working-on-a-customer is analyzed (207). Variables and factors included in the need level calculation algorithm and the working-on-a-customer timing detection algorithm are corrected and tuned based on the results of the analysis (209). The results of the correction and tuning are reflected in the algorithms (211). Thus, the program evolves.

FIG. 3 shows a process for calculating rank variables that indicates needs level of a given customer. Data such as the basic attributes of the customer, attributes of a car previously owned by the customer, attributes of a car presently owned by the customer, and information on car life activities are stored in the various databases described with reference to FIG. 1 (301). The data are classified into a basic factor set and a plurality of extended factor sets. Combination of the basic factor set and extended factor sets is used to identify the needs property of the customers.

In one embodiment, the basic factor set is provided for all target customers and includes factors provided in Table 1.

TABLE 1
Basic factor set

Factors obtained from a contract document
Name Sex Age Presently owned car Car insurance
Unsettled bill
Factors obtained from questionnaires filled in when sales are
done
Family Profession Driving history
Factors obtained from the system

In this embodiment, the extended factors are classified into extended factor set 1, extended factor set 2, and extended factor set 3. Extended factor set 1 is for target customers who previously owned cars. Extended factor set 2 is for target customers who entered cars in service shops that are not made by ABC Company and customers who own cars made by ABC Company. Extended factor set 3 is for target customers who filled in these items in questionnaires when sales are done. Table 2 provides examples of these factors. In another embodiment, the extended factor set 3 is included in the basic factor set.

TABLE 2

Extended factor set 1
Factors obtained from the system and questionnaires filled
in when sales are done
Previously owned car
Extended factor set 2
Factors obtained from questionnaires filled in when sales are
done or when cars are entered into service shops
Place of compulsory car inspection 42-month inspection
status Place of 12-month inspection Car delivery
Substitution car rent Place of oil change place Frequency
of oil change Oil brand Frequency of car wash Method of
car wash
Extended factor set 3
Factors obtained from a questionnaire filled in when the
contract is signed
Annual income Annual household income

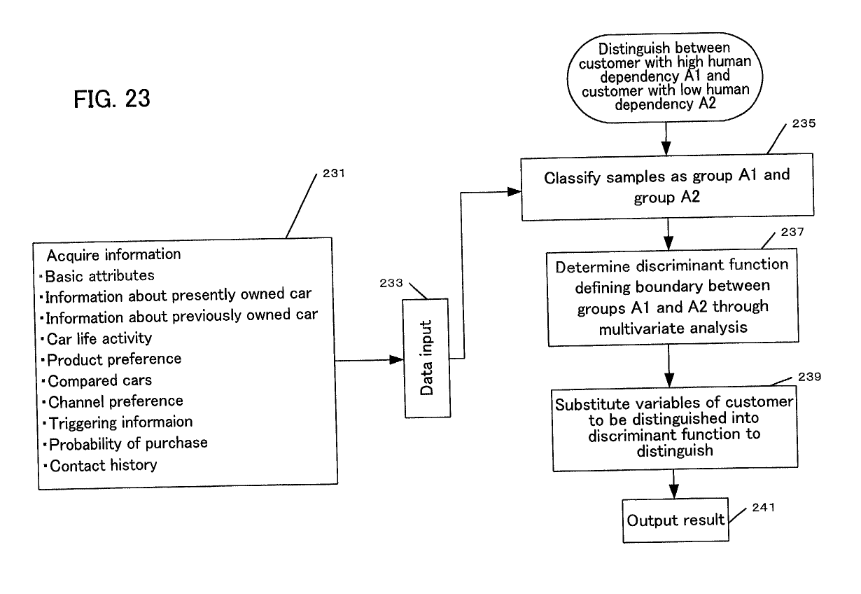

The customer needs include the items shown in block 303 in FIG. 3. Each need type is discriminated based on a predetermined combination model of the basic factor set and the extended factor set, and its ranking is determined (305) FIG. 23 shows the process flow of the discriminant analysis. The discriminant analysis itself is a well-known method and therefore the detailed description will not be made here. Discrimination can be made using a linear discriminant function that separates two groups with a single straight line or using Mahalanobis distance that separates two groups with a quadric curve.

The example shown in FIG. 23 distinguishes customers between those A1 having higher human dependency, and those A2 having lower human dependency. Data on a large number of samples (231) obtained from questionnaire survey and other sources are input to the system (233). The samples are divided into group A1 and group A2 (235). A statistical analysis is used to determine a discriminant function that defines a boundary between group A1 and group A2 (237). Once the discriminant function is determined, each data value corresponding to each customer is determined as to which side of the discriminant boundary (discriminant curve) it belongs to (239). Thus, customers are classified into two groups. In addition to merely determining which group a customer belongs to, ranking of each customer in a group can be determined according to a discriminant score, which can be obtained by entering the variables of the customer into the discriminant function.

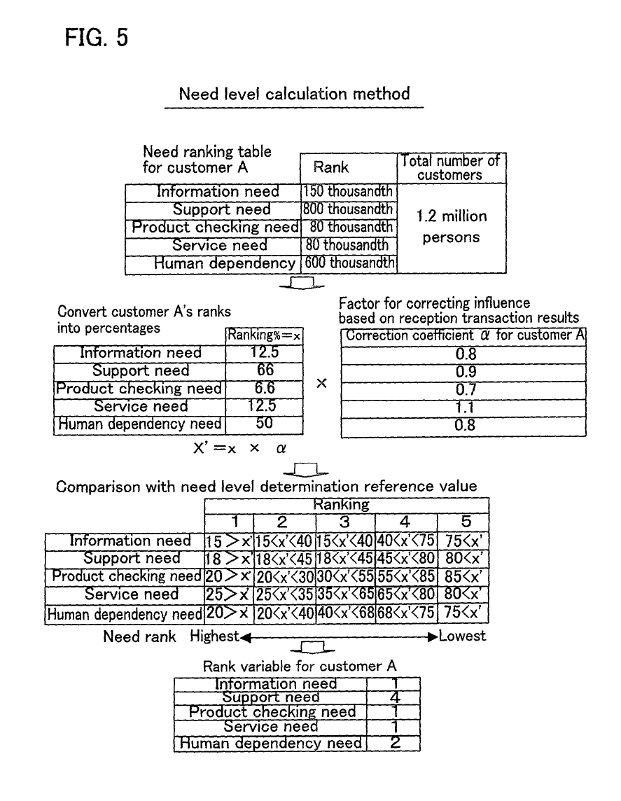

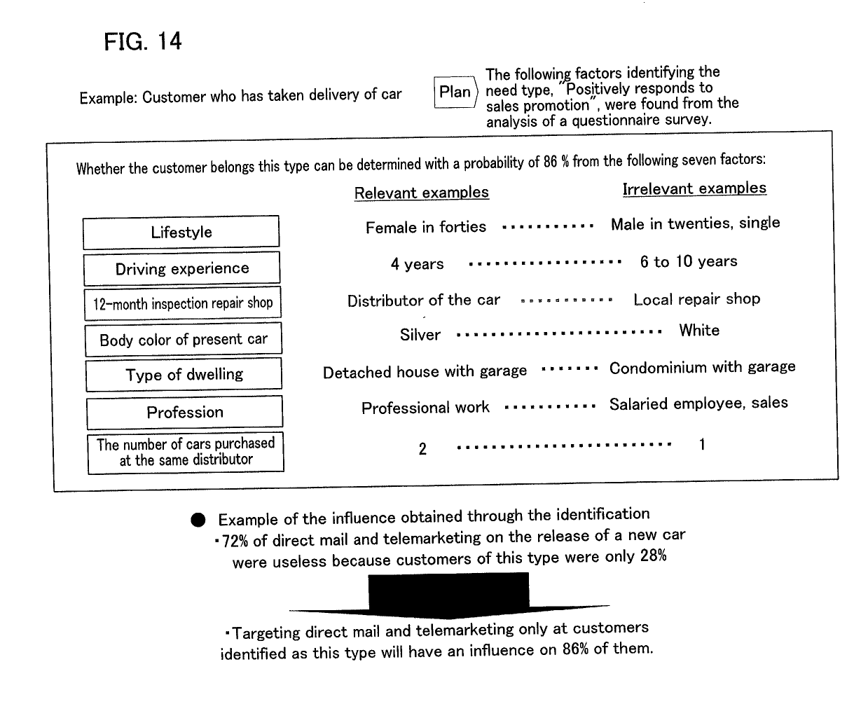

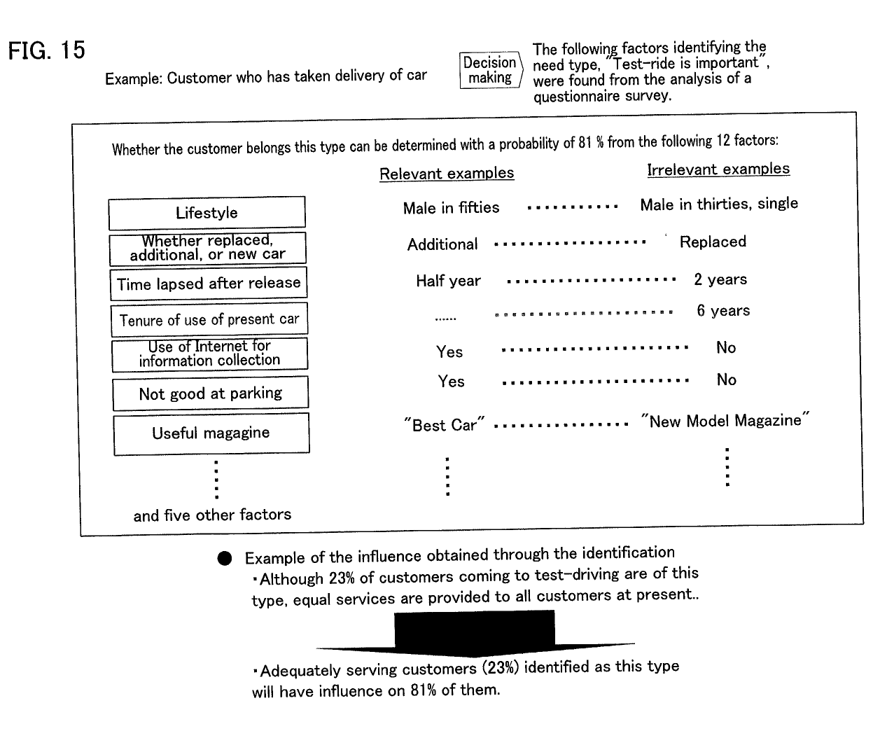

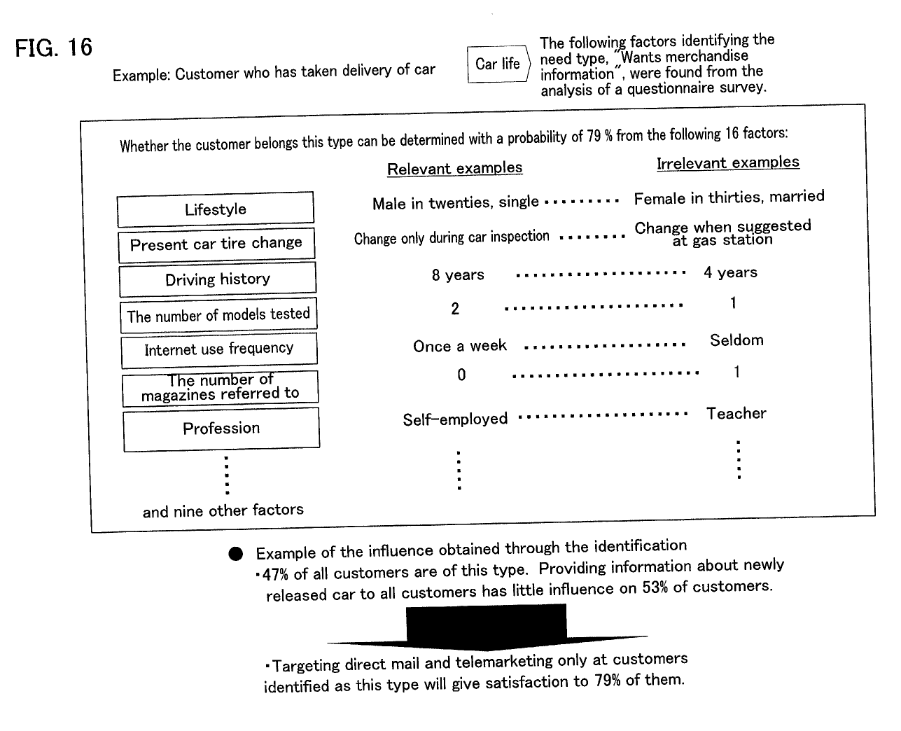

FIG. 14 shows factors for identifying a need type, “a customer who positively responds to sales activities (human dependency need)”, which is obtained from analysis of questionnaires. FIG. 15 shows factors for identifying a need type, “a customer to whom a test ride is important (product checking need)”, which is obtained from the analysis of questionnaires. FIG. 16 shows a need type, “a customer who wants merchandise information (information need)”, which is also obtained from the analysis of the questionnaires. These factors and the discriminant analysis scheme are used to identify need types. Ranking is performed based on a value, that is, a discriminant score obtained by entering data on each customer into the discriminant function. Thus, the rank of each customer is determined at step 309. This process will be described in detail with reference to FIG. 5.

It is assumed that there are five need types, “information need”, “support need”, “product checking need”, “service need”, and “human dependency need”, as shown in a need ranking table for customer A in FIG. 5. The need type shown in FIG. 14 corresponds to “human dependency need”, the need type shown in FIG. 15 corresponds to “product checking need”, and the need type shown in FIG. 16 corresponds to “information need.”

Customer A has registered himself/herself on the Web site of ABC Company. Factors that affect the above-mentioned needs are retrieved from data about customer A which is stored in the plurality of databases described earlier to identify the needs of customer A and his/her rank in the data set is determined (309).

Ranks determined in this way are shown in the need ranking table for customer A shown at the top of FIG. 5. For example, information need of customer A is one hundred fifty thousandth in the total number of customers of one million two hundred thousand. The rank of each need is converted into percentage to the population parameter (the total number of customers) of the data set. The resultant percentage value is multiplied by a correction coefficient for customer A to calculate a need level, X′ (311). The correction coefficient is set according to the property of each customer based on feedback resulting from the operation of this system. In the customer A's example, the correction coefficient for information need is set to 0.8, which is determined based on the results of transactions in the past showing that information has strong influence on customer A's purchasing decision. The need level is a rank or order in percent in the total number of customers, the smaller the value, the higher the need level.

The need level of each of the five need types calculated in this way is classified into five ranks or classes 1 to 5 based on a determination reference value as shown in FIG. 5 (313). Examples of the determination reference values for individual needs are shown in a ranking table in FIG. 5. Rank 1 represents the most significant influence. The larger the rank value, the smaller the influence is.

Rank variables for customer A determined in this way are shown in the table at the bottom of FIG. 5 (315).

FIG. 6 shows a process flow for determining the timing of working-on-a-customer by ABC Company. When a customer completes a login to the Web page of ABC Company (401), a menu for selecting content appears on the customer's browser. The customer can select one of a plurality of contents (403), “Model selection” 405 through “Event information” 419. This menu page also contains an item for returning to the top page 421. When a content having substantial information is selected from the group of contents “Model selection” 405 through “Event information” 419, a flag indicating the selected content is set (425).

If this is the first time that the customer logs in to this Web page (427), the process proceeds to block 429, where access start time is set, click count is cleared, a purchase stage status constant is obtained, and a content depth coefficient is initialized. If this is not the first login, the process proceeds to block 431, where an access count, click count, and daily access count are incremented and the content depth coefficient is obtained.

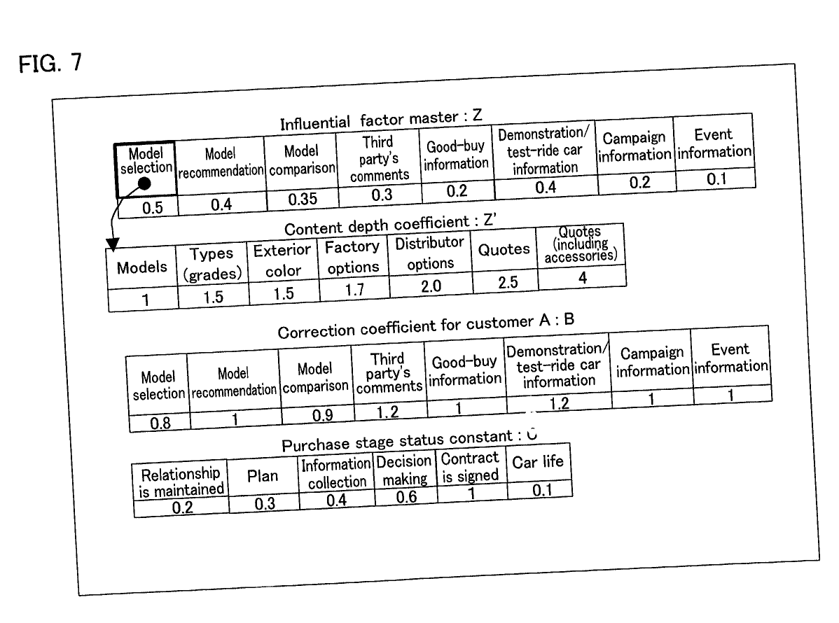

Now, influence of the content is calculated with reference to the table shown in FIG. 7. Value Z, which is stored in an influential coefficient master table, is assigned to each content category as shown in the table at the top of FIG. 7. For example, value Z for “Model selection” is 0.5 and that for “Model recommendation” is 0.4. Content depth coefficient Z′ indicates the depth of access in the hierarchical structure of the Web pages. In the category of “Model selection”, for example, the depth of the page for making car model selection is 1, the depth of the page for making type (grade) selection is 1.5, the depth of the page for selecting exterior colors is 1.5, and the depth of the page for requesting quotes is 2.5. Correction coefficient B for each customer is used for correcting the influential coefficient according to the character of the customer in consideration of the results of the operation of this system. Purchase stage status constant C indicates at which stage a customer is in the process of purchasing a car. For example, the purchase stage status constant of a customer at the stage of collecting information for purchasing a car is 0.4. Content influence M is defined by the following equation.

(Equation 1)

Content influence M=(Z×Z′)×B+C

Next, a browse influence value, which indicates the influence of a given content of ABC Company on car purchase by customer A, is calculated according to the following equation.

(Equation 2)

Browse influence value=(access count+daily access count+click count)×M

The browse influence value thus obtained for customer A is compared with an increment threshold (437). If it exceeds the reference value, the corresponding appropriate content influence value for the customer is incremented. For example, it is assumed that customer A proceeds from the “Model selection” (influential coefficient Z=0.5) menu in the chart in FIG. 7 to the quotes content having content depth Z′=2.5. Correction coefficient B for the model selection content for customer A is 0.8 as shown in a table in FIG. 7. If purchase stage status constant C for customer A is at an information collection stage (C=0.5), content influence M for customer A is 1.5 according to Equation 1.

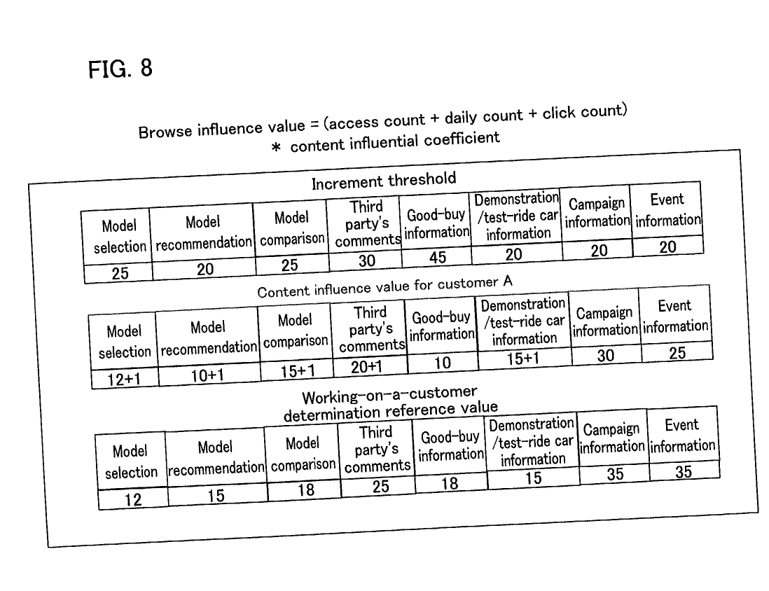

If access count+daily count+click count=18, the browse influence value for customer A is 27 according to Equation 2. As can be seen from the uppermost table in FIG. 8, the browse influence value of 27 is larger than the increment thresholds of 25 for model selection. Accordingly, the content influence values for the contents that are relevant to model selection, namely “model selection”, “model recommendation”, “model comparison”, “third party comments” and “demonstration/test-ride” are incremented with respect to customer A (439, FIG. 6). This is shown in the center table in FIG. 8.

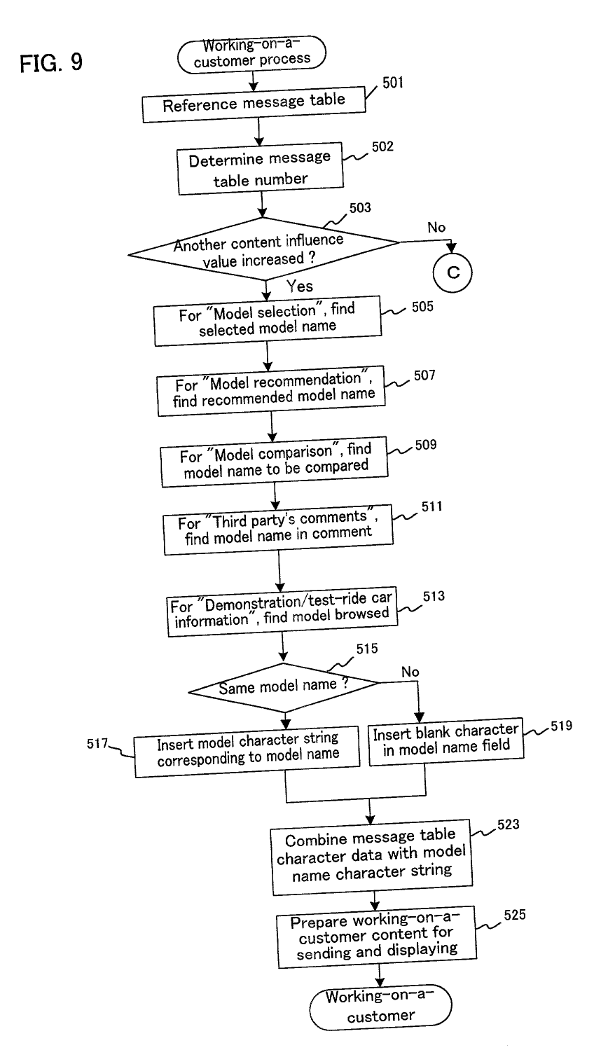

The content influence values thus updated for customer A are compared with reference or threshold values for determination of working-on-a-customer (441). Examples of the reference values are shown in a table at the bottom of FIG. 8. If the content influence value of any of the contents exceeds the corresponding reference value, a process for working on customer A from ABC Company is performed. In this example, the content influence value for the “model selection” content for customer A becomes 13, which exceeds the corresponding reference value of 12. The content influence value for the “demonstration/test-ride car information” is 16, which also exceed the corresponding reference value of 15. As a result, a working-on-a-customer process shown in FIG. 9 starts for customer A.

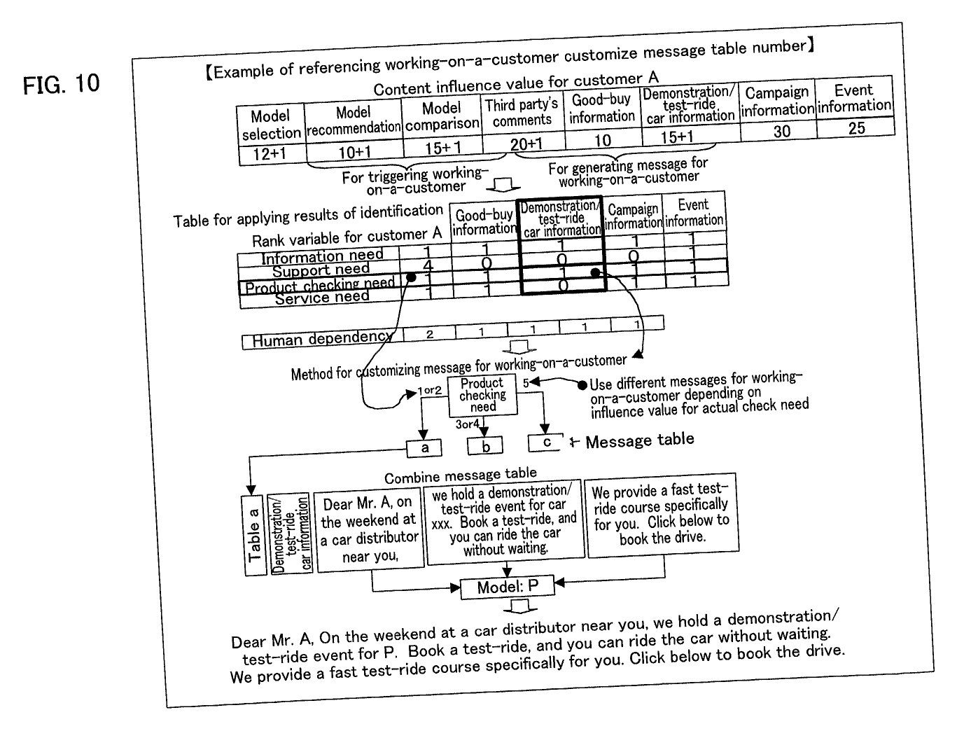

The process for working-on-a-customer from company A after the process shown in FIG. 6 will be described with reference to FIGS. 9 and 10. First, reference is made to content influence values for customer A at the top of FIG. 10. While the process will be described for customer A, who may be any given customer, processes similar to this are performed for all customers in the database. As shown in the table in FIG. 10, contents are classified into two groups, one being the group that triggers working-on-a-customer, and the other being the group that generates a message for working-on-a-customer. In the example of customer A, the working-on-a-customer process is started relative to customer A in response to the content influence value for the “model selection” content exceeding the reference value for initiating the working-on-a-customer process. In addition, the content influence value for the “demonstration/test-ride car information” has also exceeded a corresponding reference value. A process will be carried out to generate a message for providing demonstration/test-ride car information to customer A.

In this embodiment, the rank variables described with reference to FIG. 5 are used to construct a message for working-on-a-customer. When the message for working-on-a-customer is to be formed based on the influence value for the “demonstration/test-ride car information” content as shown in FIG. 10, relevant need types having significant rank variables such as “1” are “Information need”, “product checking need”, and “human dependency.” The table in the middle of FIG. 10 indicates the need types having the rank of “1” in the column of “demonstration/test-ride car information.”

In FIG. 10, with respect to the “product checking need”, the rank variable is “1”. The system in this embodiment is programmed to select a message table “a” responsive to rank “1” or “2” in the product checking need. This is shown in the middle to lower section of FIG. 10. That is, if the product checking need is 1 or 2, message table “a” is selected. If the product checking need is 3 or 4, message table “b” is selected. If it is 5, message table “c” is selected.

Referring again to FIG. 9, a message table is thus determined (502). Whether influence values for any content other than the “demonstration/test-ride car information” content is increased is determined (503). If the influence value for the “model selection” content is increased, a model name selected by customer A is found from the Web activity history database 40 (FIG. 1) (505). Similarly, if the influence value for the “model recommendation” content is increased, a recommended model name is found from the Web activity history database 40 (507). If the influence value for “model comparison” content is increased, model names to be compared with each other are found from the Web activity history database 40 (509). If the influence value for the “third party's comments” content is increased, a model name in the comment information is found from the Web activity history database 40 (511). In addition, the demonstration/test-ride content browsed by customer A is retrieved from Web activity history database 40 to find a browsed model name (513).

If there is the same model name in the model names thus found, such model name is inserted into the message for working-on-a-customer created in the process shown in FIG. 10 (517). If no same model names are in the model names, a blank character is inserted in the model name field in the message for working-on-a-customer (519). An example of the message thus generated is shown at the bottom of FIG. 10. In this way, character data in the message table is combined with the model name (523) to complete a working-on-a-customer content (525).

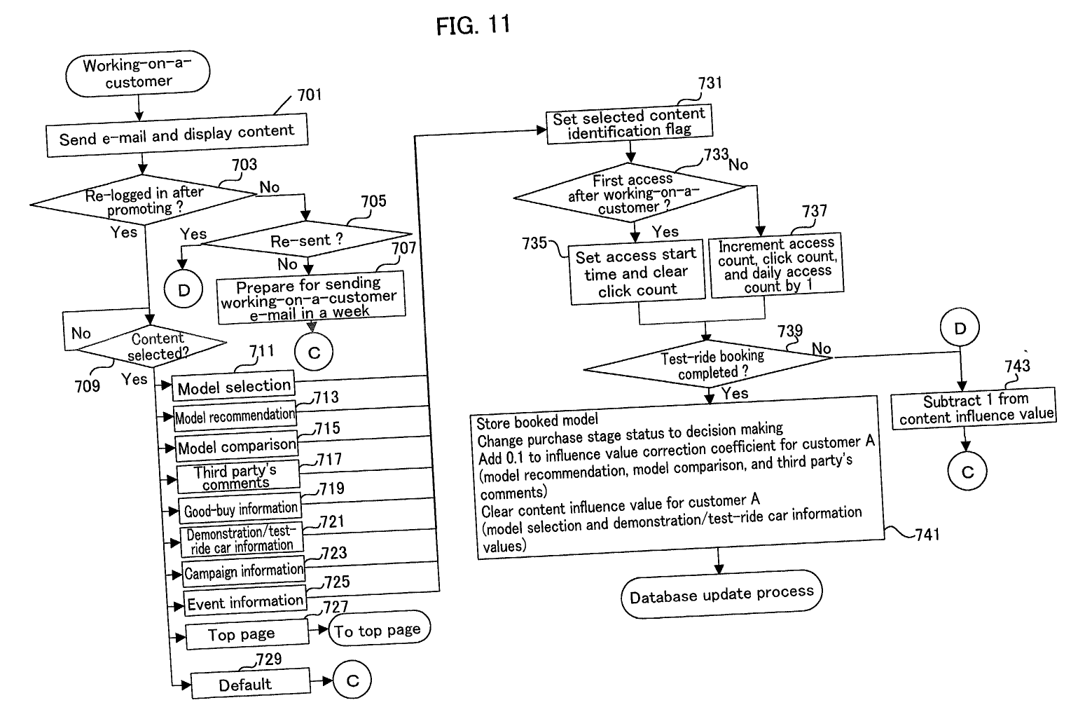

Referring to FIG. 11, the content thus completed is sent or notified to customer A in a manner described earlier with respect to FIG. 1 (701). This working-on-a-customer may take various forms, including contact by sales staff and direct male by ordinary male, as well as the form of Web site and e-mail.

If a customer to be worked on is decided in the process shown in FIG. 9, the customer comprehension engine 57 edits a content that matches the content influence values for the customer to be worked on according to directions from the customer comprehension engine 20 shown in FIG. 1. When the customer to be worked on subsequently logs into the Web page of ABC Company, a page edited for the customer will be presented to the customer. Company ABC can prompt the customer to access the page by notifying the customer that the special page is made available (701).

After working-on-a-customer to a customer is performed according to the system of the present invention, a response from the customer is detected and data in databases for the customer is modified to adjust the system so as to be able to prompt the customer more effectively in the future.

After the working-on-a-customer is performed, the activity history server 27 (FIG. 1) detects whether there is a login to the Web page by a customer to be worked on (703). If there is no login by the customer for a predetermined time period, for example two weeks, and working-on-a-customer has not been resent to the customer, sending of an inductive male to the customer in a week is scheduled (707). When the customer logs into the Web page after the working-on-a-customer, a message provided specifically for the particular customer is displayed on the menu page. On the menu page, a menu item for a content specifically edited is blinked or marked with a special symbol to attract the customer's attention.

In the example described with respect to customer A, the message for working-on-a-customer shown at the bottom of FIG. 10 appears on the browser. Demonstration/test-ride information 721 among the menu items shown in FIG. 11, Model selection 711 through Event information 725, is edited specifically for customer A and set so as to blink. When customer A selects one of the menu items and clicks it, a selected-content identification flag is set (731). If this is the first access after the working-on-a-customer (733), access start time is set and the click count is cleared (735). If this is the second or subsequent access, the access count, click count, and daily access count are incremented by 1 (737).

In this example, if a booking for a test-ride is made by customer A on the Web page (739), the booked model is first stored in the database, purchase stage status (in the database) is changed to the “decision making” stage, 0.1 is added to a correction coefficient for appropriate content influence value for customer A, and the content influence value is cleared for subsequent calculation. The test-ride booking may be performed by other means such as telephone or e-mail. In such a case, the sales staff or call center staff enters data about the test-ride booking into the system. If customer A makes no test-ride booking responsive to this working-on-a-customer, 1 is subtracted from the content influence value (743).

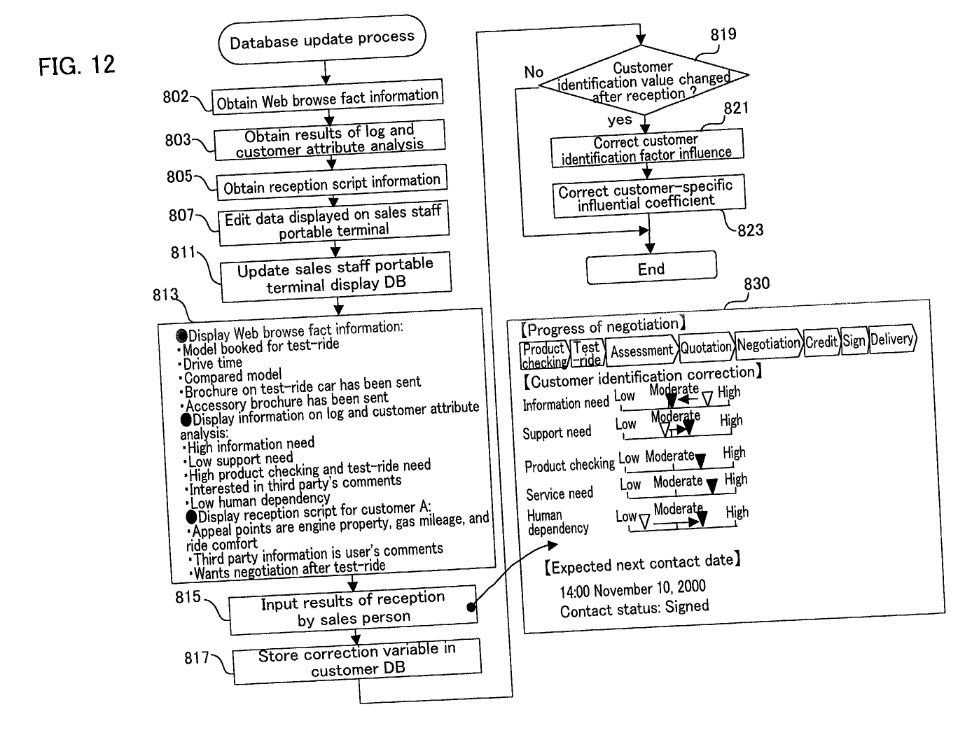

Then, a database update process in FIG. 12 is started. Fact information concerning Web browse by a customer of interest, customer A in this example, is retrieved from databases (802), the results of the analysis of the log and attributes of the customer are retrieved from the databases (803), reception script information is retrieved (805), data displayed on the portable terminals of the sales staff is edited (807), and database for providing information to portable terminals of the sales staff is updated (811).

Block 813 shows information displayed on a portable terminal of the sales staff or a terminal at a sales office after the above-described steps. The fact information from the Web site includes such information as model name of the car booked for test-ride, time booked for test-ride, models of cars compared by customer A, and information on delivery of a brochure of the model or a brochure of accessories.

Need information resulting from the analysis of the log and customer attributes of customer A includes information indicating that customer A has high information need, is interested in third party's comments, has low support need, high product checking and test-ride needs, and has low human dependency (dependency on the contact with the sales staff or other personnel).

The information to be displayed on a portable terminal of sales staff for reception of customer A includes information that would be of interest to customer A. Such information may include engine property, gas mileage, and riding comfort. It may also include information that third party comments that customer A is interested is comments of the users of the car. It may also include information that customer A would be interested in business discussion after test-ride.

After the sales person serves customer A's test-ride based on the above-mentioned information provided by the system, the sales person inputs the results of the test-ride as shown in block 830 (815). The sales person inputs information indicating in what stage the business discussion is. The stage may be selected from stages of product checking, test-ride, assessment, quotation, negotiation, credit application, sales done, and delivery. Based on the results of the service performed for customer A, the sales person modifies “information need”, “service support need”, “product checking need”, “service need”, and “human dependency” indicated by the system. The sales person also inputs the expected date on which he/she will contact customer A.

Correction variables based on the inputs by the sales person are stored in the customer database 30 (817, FIG. 12). The customer comprehension engine 20 determines whether any customer identification values are changed after servicing customer A (819), and if changed, corrects customer identification factor influence (821), and corrects customer-specific influence coefficients (823). In this way, the system is updated based on the results of the working-on-a-customer according to the calculations by the system, enabling more accurate calculations.

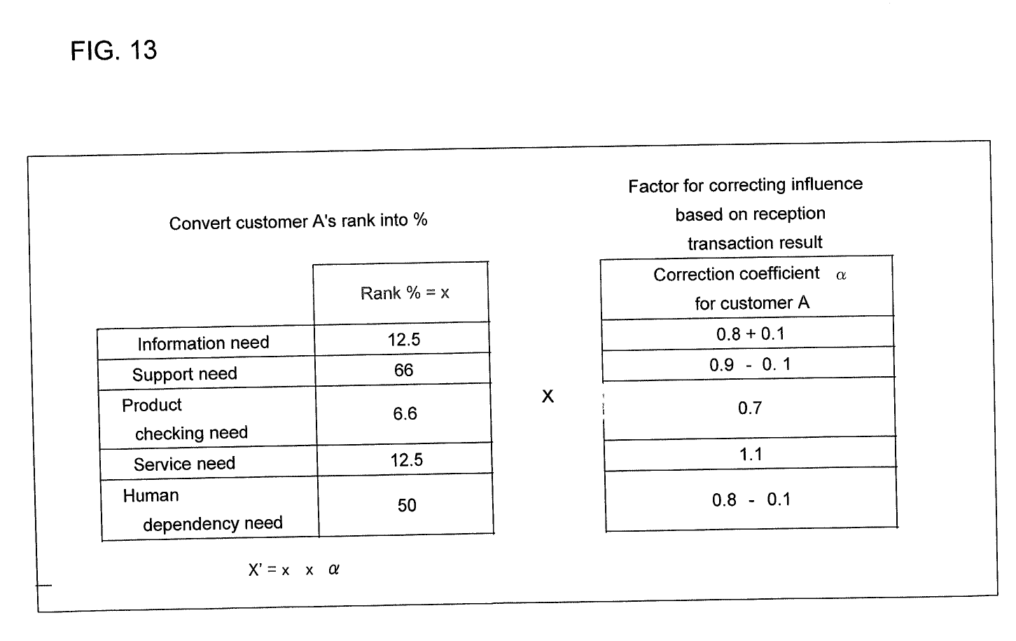

FIG. 13 shows a particular example of corrections at steps at 821 and 823 in FIG. 12. Correction coefficients for customer A's needs are modified based on the results of the reception of customer A shown in block 830 in FIG. 12 as entered by the sales person. For example, the information need of customer A, which stands in a position indicated by a white triangle in block 830 according to a calculation by the customer comprehension engine, is moved by the sales person to a position indicated by the black triangle. Based on this, the customer comprehension engine reduces influence of the information need relative to customer A. That is, as shown in FIG. 13, the engine increases the percentage ranking of customer A (a higher number indicates a lower rank from the top). In the example shown, the correction coefficient of the information need is corrected from 0.8 to 0.9. Similarly, the correction coefficient for influence of support need, product checking need, service need, and human dependency for customer A is modified based on the results shown in block 830 in FIG. 12. Corrected influence X′ of each of the needs can be expressed as:

X′=(rank %)X×(correction coefficient)α.

Interpolation of Basic Factors and Acquisition of Absent Factors

As described earlier, the needs property of a customer of interest are identified by using a combination of basic factors and extended factors shown in Tables 1 and 2. Therefore, if any of the factors used for identification of a particular need type is absent, reliability of the identification of the need type will degrade. In one embodiment of the present invention, if a factor required in identifying a given need type is absent, a process for automatically acquiring the absent factor is activated. In another embodiment of the present invention, if a factor required in identifying a given need type is absent, an interpolation factor is used in place of the absent factor to perform a calculation for identifying the need type.

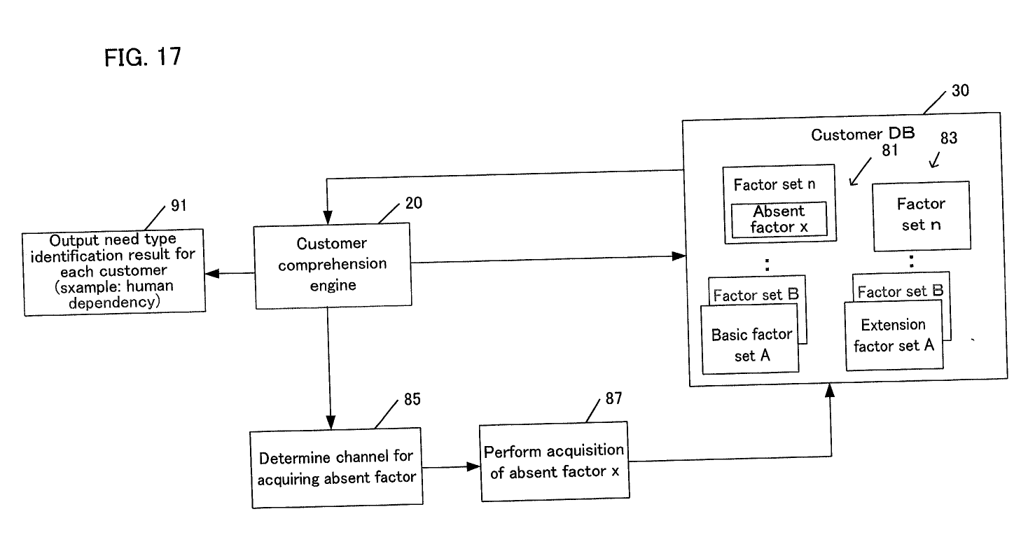

Referring to FIG. 17, the customer comprehension engine 20 accesses the customer database 30 to obtain basic factors and extension factors required for performing a calculation for identifying the need type, “human dependency”, for example. If data on factor x required for this calculation is not contained in the customer database 30. The customer database 30 informs the customer comprehension engine 20 that factor x is absent. In response to this, the customer comprehension engine 20 determines a channel for obtaining the absent factor (85), obtains the absent factor (87), and inserts it in the corresponding factor set in the customer database 30.

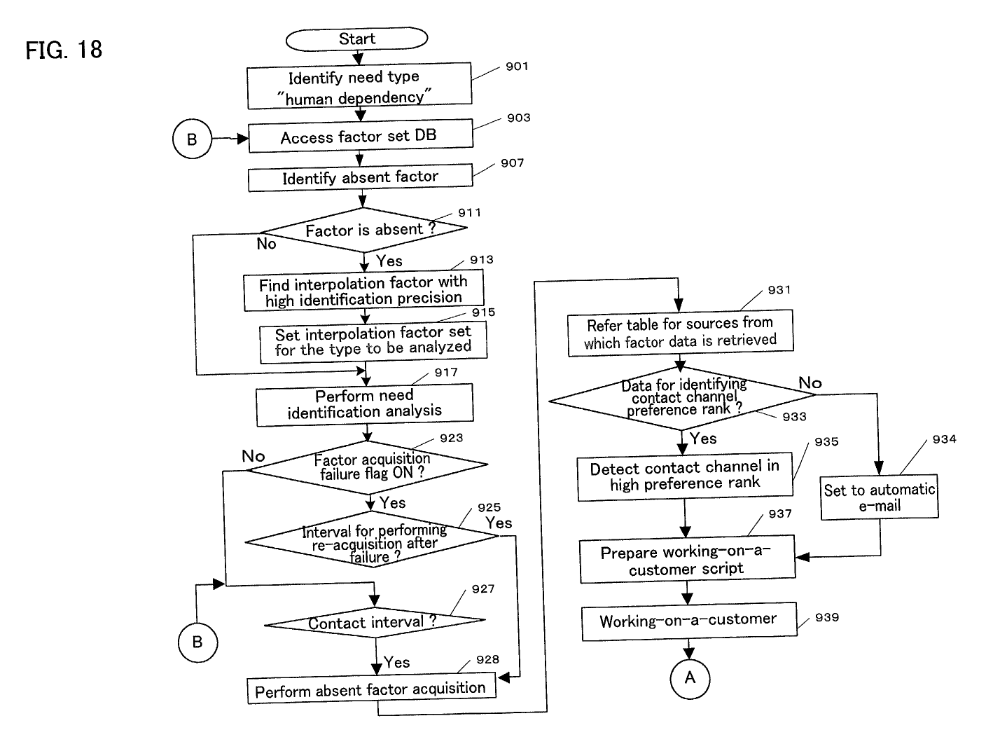

FIG. 18 shows a flowchart of the process for obtaining and interpolating the absent factor. The customer comprehension engine 20 accesses the customer database 30 in response to a request (901) for identifying a need type, “human dependency”, for example (903). The customer server 35 (FIG. 1) checks to see if data on all basic factors and extension factors required for calculating this need type is provided and identifies any absent factor(s) (907). If there is no absent factor, it provides the required factor data to the customer comprehension engine 20. The customer comprehension engine 20 performs an analysis for identifying the need type (917).

If it is determined at block 911 that one of the factors lacks data, the best interpolation factors for that lacking factor are searched (913). A set of thus found interpolation factors is set for the object to be analyzed (915), and is provided to the customer comprehension engine 20. The customer comprehension engine 20 uses the provided basic factors, extension factors, and interpolation factors to perform the identification analysis of the need type.

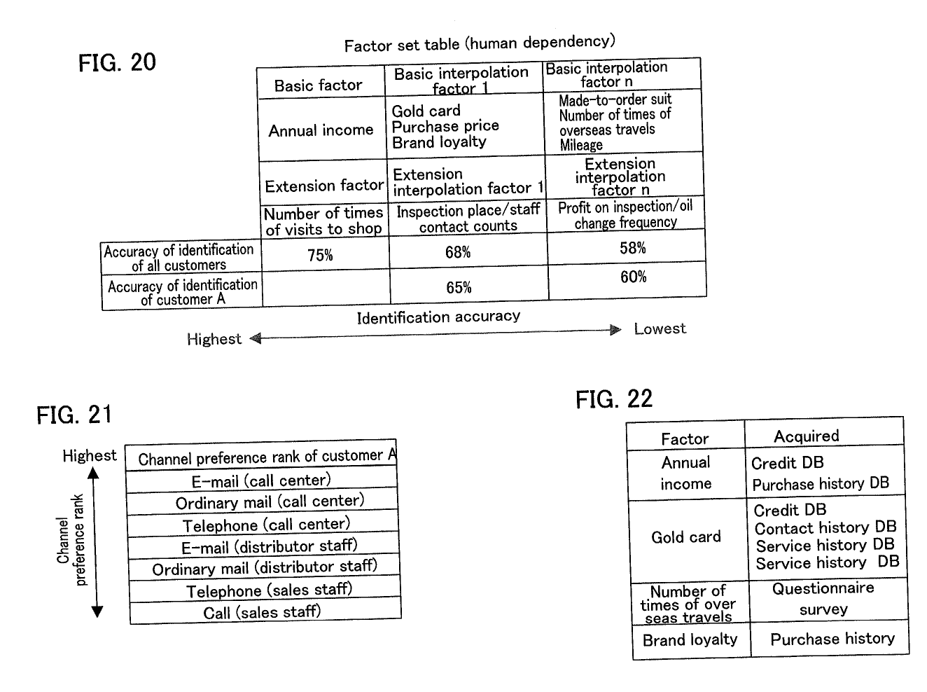

FIG. 20 shows examples of the basic factors, extension factors, basic interpolation factors, and extension interpolation factors. In this example, annual income is a basic factor. If data on annual income of the customer, which is a basic factor required for identifying a need type, is not contained in the customer database 30, the annual income is treated as an absent factor. The customer database 30 contains, basic interpolation factor set 1 relative to annual income data. The basic interpolation factor set 1 includes “Gold Card”, “purchase price”, and “brand loyalty”. Basic interpolation set n (where n may be any number) may include “made-to-order suit”, “the number of times of over seas travels”, and “mileage.”

FIG. 20 shows that human dependency can be obtained with an accuracy of 75%, that is hit rate of 75%, when human dependency is calculated based on a basic factor “annual income” and an extension factor “the number of visits to shop”. When “human dependency” is calculated based on basic interpolation factor set 1 and extension interpolation factor set 1, which is interpolation factor set to be used when data for an extension factor “the number of visits to shop” is absent, the result can be obtained with an accuracy of 68% over all the customers. When the “human dependency” of customer A is calculated, the result can be obtained with an accuracy of 65%, for example.

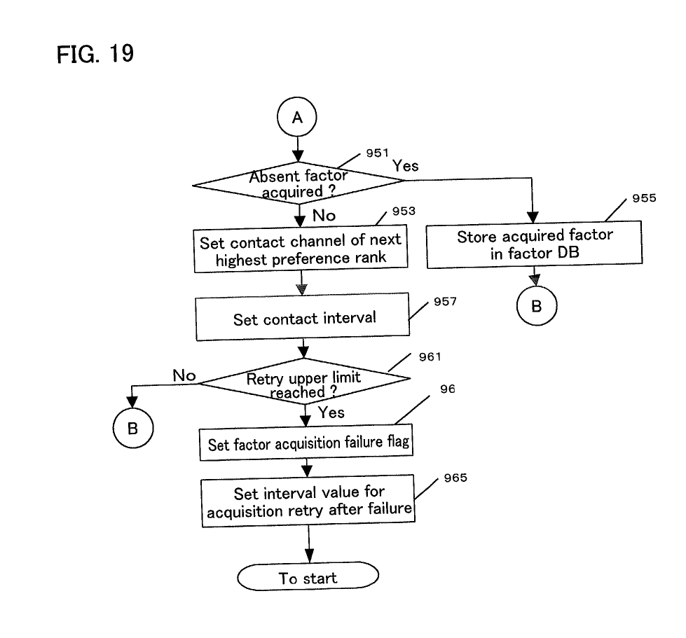

Returning to FIG. 18, it is determined in determination block 923 whether a factor acquisition failure flag is set in determination block 963 in FIG. 19. If the flag is set, the process proceeds to block 925. In block 925, it is determined whether the time interval has elapsed, the time interval being set in block 965 in FIG. 19 for starting a process for re-acquiring the factor after the failure. If the interval has elapsed, the process proceeds to block 928, where the acquisition of the absent factor is performed. If the factor acquisition failure flag is not set in block 923, the process proceeds to block 927. In block 927, it is determined whether a time interval for contacting a customer of interest, which is set in block 957 in FIG. 19, has elapsed. If the time interval has elapsed, the process proceeds to block 928, where a process for acquiring the absent factor is started.

First, a table from which factor data are to be obtained is referred to in block 931. The table has a structure as shown in FIG. 22, for example, which indicates that data about the “annual income” factor can be obtained from a credit database or a purchase history database. Data on “the number of times of overseas travels” can be obtained from questionnaire survey.

After a database from which data can be obtained is determined by referencing the table, the process proceeds to block 933, where it is determined whether data for identifying contact channel preference of the customer of interest is stored in the database. FIG. 21 shows an example of contact channel preferences of a given customer. Because the contact channel of the highest preference for customer A is a contact by e-mail, e-mail is selected for the contact channel (935) and a working-on-a-customer script is prepared (937). If there is no data for identifying contact channel preference, automatic e-mail transmission is selected (934). After the working-on-a-customer script is prepared in this way, working-on-a-customer is performed (939). In this example, the e-mail is sent.

Referring to FIG. 19, when data on the absent factor is acquired (951), the data is stored in a factor database in the customer database (955). The data is used for subsequent calculation for identifying need types. If the absent factor cannot be acquired, a contact channel of the next highest preference is selected (953) and the contact interval is set to 30 days so that a particular customer is contacted too often (957). If a predetermined upper limit of retries is not exceeded, the process returns to block 927 in FIG. 18, where the process for acquiring the absent factor is started. If the upper limit of retries is reached, the factor acquisition failure flag is set and the time interval to the next retry is set to three months, for example (965).

While the present invention has been described with respect to the specific embodiments, the present invention is not limited to the embodiments.

What is claimed is:

1. A computer system for analyzing needs of customers based on information concerning the customers, comprising:
a database for storing data on basic factors for understanding the customers, and
a customer comprehension engine for analyzing needs property of one or more of the customers based on the data on the basic factors,
wherein the database stores data of interpolation factors to be used in place of the data on the basic factors if data for the basic factors is absent, and the customer comprehension engine is configured to use the data of interpolation factors corresponding to the basic factors to calculate the needs property of one or more of the customers if the data on the basic factors required in calculating the needs property of the one or more of the customers is absent.

2. The computer system according to claim 1, wherein the needs property of the customers includes one or more of information need, support need, product checking need, service need, and human dependency need, and the customer comprehension engine is configured to activate a process that performs working-on-a-customer for acquiring data if the data of interpolation factors is absent.

3. The computer system according to claim 2, wherein the process comprises selecting for a given customer a contact channel of high preference.

4. A computer system for analyzing information concerning customers, comprising:
a database for storing data on basic factors for understanding the customers, and
a customer comprehension engine for analyzing needs property of the customers based on the basic factors,
wherein the computer system is configured to activate a process for performing working-on-a-customer in order to acquire related data if data on the basic factors required for calculating the needs property of the customers is absent.

5. The computer system according to claim 4, being configured to use data of interpolation factors in place of the data on the basic factor to calculate the needs property of the customers if the related data cannot be acquired by performing the working-on-a-customer.

6. Method for analyzing needs of customers based on information concerning the customers, comprising:
preparing and storing in a database data on basic factors for understanding the customers,
storing in the database data of interpolation factors to be used in place of the data on the basic factors if data for the basic factors is absent,
executing a computer program for analyzing needs property of one or more of the customers based on the data on the basic factors, and
calculating the needs property of one or more of the customers using the data of interpolation factors corresponding to the basic factors when the data on the basic factors required in calculating the needs property of one or more of the customers is absent.

7. The method according to claim 6, wherein the needs property of the customers includes one or more of information need, support need, product checking need, service need, and human dependency need, and the customer comprehension engine is configured to activate a process that performs working-on-a-customer for acquiring data if the data of interpolation factors is absent.

8. The method according to claim 7, wherein the process comprises selecting for a given customer a contact channel of high preference.

9. Method for analyzing information concerning customers, comprising:
storing in a database data on basic factors for understanding the customers,
calculating needs property of the customers based on the basic factors, and
initiating a process for working on one or more customers in order to acquire relevant data if data on the basic factors required for calculating the needs property of the one or more customers is not included in the database.

10. The method according to claim 9, further comprising using data of interpolation factors in place of the data on the basic factor to calculate the needs property of the customers if the related data cannot be acquired by working on the one or more customers.
